(19) United States
(12) Patent Application Publication
(10) Pub. No.: US 2012/0059945 A1
(43) Pub. Date: Mar. 8, 2012

(54) Data-Transfer Method and Terminal

(75) Inventor: Satoru Yamaguchi, Nagoya-shi (JP)

(73) Assignee: BUFFALO INC., Nagoya-shi (JP)

(21) Appl. No.: 13/227,488

(22) Filed: Sep. 8, 2011

(30) Foreign Application Priority Data
Sep. 8, 2010 (JP) 2010-200724

(51) Int. Cl. G06F 15/16

(52) U.S. Cl. 709/230

(57) ABSTRACT

A first terminal connectable to a wireless LAN pre-stores utilization information required in order for a terminal to utilize the wireless LAN. At least one of either the first terminal, or a second terminal connectable to the wireless LAN, determines whether a predetermined operation requesting data transfer is present in the one terminal, and on the basis of the predetermined operation the first terminal transfers its stored utilization information via wireless means to the second terminal. The second terminal stores the utilization information transferred from the first terminal.

### CROSS REFERENCE TO RELATED APPLICATION

The disclosure of Japanese Patent Application No. 2010-200724, filed on Sep. 8, 2010, is incorporated herein by reference.

### BACKGROUND OF THE INVENTION

1. Field of the Invention

The present invention relates to data-transfer methods and terminals, and, more particularly, relates to technology for transferring data between terminals in systems including a plurality of terminals connectable to a wireless LAN (local area network).

2. Description of the Background Art

Wireless-LAN connectable terminals conventionally acquire utilization information for utilizing a given wireless LAN (connection information and peripheral device information) by carrying out information exchanges with a relay device (e.g., an access point), on the given wireless LAN to be utilized, within the communications range in which communication with the relay device is possible. This “connection information” is SSIDs (extended service set identifiers), user names, passwords, etc. for making a connection with a relay device on a wireless LAN, while this “peripheral device information” is information for utilizing printers or other peripheral devices that are connected to the wireless LAN. Known examples of technology concerning wireless LANs include the technology disclosed in Japanese Laid-Open Patent Publication No. 2008-47954.

In a general situation in which a first terminal is employed to attempt to connect to a given wireless LAN where utilization information is not retained, the usual practice is to transfer utilization information on the given wireless LAN, from a second terminal that retains the utilization information, to the first terminal via a storage medium (e.g., a USB memory), and connect to the given wireless LAN at the first terminal. In recent years, however, in order that a user can conduct the transfer of utilization information by an easier method, further improvements in the technology have been called for.

### SUMMARY OF THE INVENTION

Therefore, an object of the present invention is to provide: a data-transfer method and terminals that facilitate the transfer of utilization information from one terminal to another terminal.

The present invention is directed to a data transfer method of carrying out data transfer between first and second terminals connectable to a wireless LAN. In order to attain the object mentioned above, the first terminal pre-stores utilization information required in order for a terminal to utilize the wireless LAN, and the data transfer method comprise a step of at least one of either the first terminal or the second terminal determining whether a predetermined operation requesting data transfer is present in said one terminal; a step of the first terminal, on the basis of the predetermined operation, transferring the pre-stored utilization information via wireless means to the second terminal; and a step of the second terminal storing the utilization information transferred from the first terminal.

In the transferring step, the first terminal may transfer the utilization information directly to the second terminal, or to the second terminal through a relay device on the wireless LAN. In addition, in the transferring step, the first terminal may select at least a portion of the pre-stored utilization information and may transfer the portion to the second terminal. The utilization information is information in order for a terminal to connect to a relay device on the wireless LAN or information on TCP/IP settings for a terminal. The predetermined operation is desirably at least one of either an operation in order for the first terminal to recognize the second terminal, or an operation in order for the second terminal to recognize the first terminal. Further, it is desired to add at least one of either an operation of externally inputting, to the second terminal, a predetermined code for verifying the first terminal, or an operation of externally inputting, to the first terminal, a predetermined code for verifying the second terminal.

Further, the present invention is directed to a first terminal connectable to a wireless LAN, the terminal comprising: an acquisition section for acquiring via wireless means, from another terminal different from the first terminal, utilization information required in order for a terminal to utilize the wireless LAN; and a storage section for storing the utilization information acquired by the acquisition section. Moreover, the present invention is directed to a second terminal connectable to a wireless LAN, the terminal comprising: a storage section for storing utilization information required in order for a terminal to utilize the wireless LAN; and a transmission section for transmitting via wireless means, to another terminal different from the second terminal, the utilization information that the storage section stores.

It should be noted that the present invention can be implemented in various forms. For example, the present invention can be implemented in forms such as a wireless LAN communication terminal, a data (utilization information) transfer system, a data (utilization information) transfer method, an integrated circuit and a computer program for implementing the functions of these method and apparatuses, and a storage medium having the computer program stored therein.

The present invention can be used in a data transfer system including a plurality of terminals connectable to a wireless LAN, and is useful particularly, for example, when transfer of utilization information from a terminal to another terminal is desired to be facilitated. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating the configuration of a data transfer system 10 according to a first embodiment of the present invention;

FIG. 2 is a diagram illustrating configurations of a transfer source terminal 20 and a transfer destination terminal 30 in the data transfer system 10;

FIG. 3A is a diagram illustrating an example of an operation screen displayed on a display section 26 of the transfer source terminal 20;

FIG. 3B is a diagram illustrating an example of an operation screen displayed on a display section 36 of the transfer destination terminal 30;

FIGS. 4 and 5 are diagrams illustrating flow of a data transfer process performed by the data transfer system 10;

FIG. 6 is a diagram illustrating the configuration of a data transfer system 10a according to a second embodiment of the present invention; and

FIG. 7 is a diagram illustrating flow of a data transfer process performed by the data transfer system 10a.

### DESCRIPTION OF THE PREFERRED EMBODIMENTS

Next, embodiments of the present invention will be described.

### First Embodiment

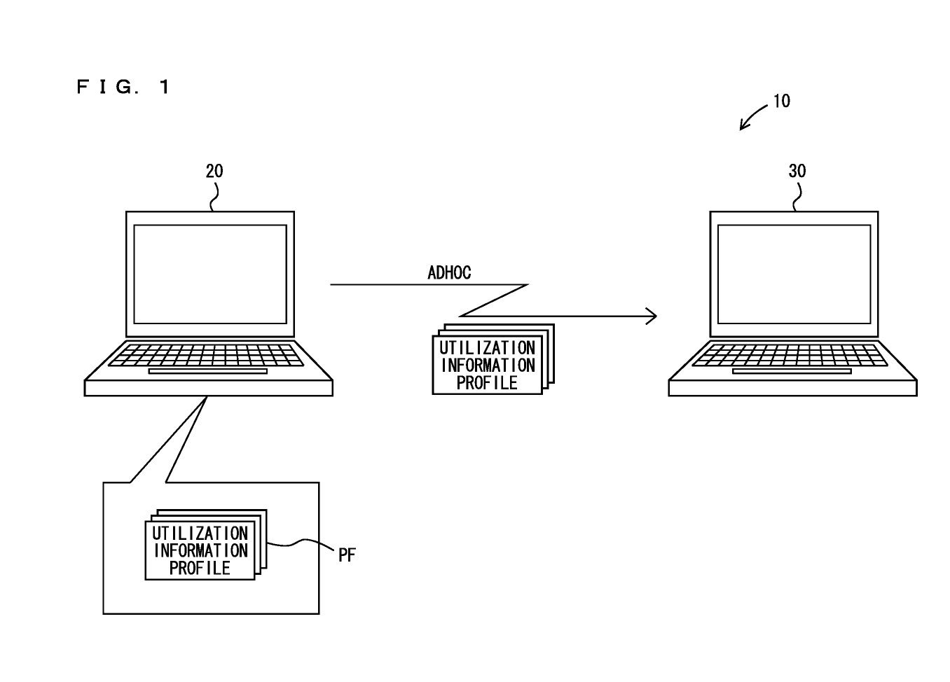

FIG. 1 is a diagram illustrating a configuration of a data transfer system 10 according to a first embodiment of the present invention. The data transfer system 10 includes terminals 20 and 30 connectable to a wireless LAN. Each of the terminals 20 and 30 is capable of performing communications according to a communications mode in which communication is performed through an access point that is a relay device of a wireless LAN (an infrastructure mode), as well as communications according to a communications mode in which communication is performed directly via wireless means between terminals (an ad hoc mode).

The terminal 20 shown in FIG. 1 has a log of infrastructure-mode based connections to a number of wireless LANs, and has utilization information (connection information and peripheral device information), for utilizing the different wireless LANs, that is acquired when the terminal 20 connects to one of the wireless LAN's access points. Specifically, the connection information is information concerning connection to each wireless LAN that is utilized, such as information for connecting to an access point and information on TCP/IP (transmission control protocol/Internet protocol) settings in the terminal. The information for connecting to an access point is SSIDs, user names, passwords, authentication keys, and encryption mode (WEP (wired equivalent privacy), WPA (Wi-Fi protected access), etc.), encryption keys, etc. used for communications with the wireless LANs. The TCP/IP settings information is the IP address (fixed or automatically acquired) and HTTP proxy of each wireless LAN, etc. The peripheral device information is information on peripheral devices such as printers and scanners that are utilized by users in each wireless LAN that is utilized. For example, when a plurality of printers are connected to a utilized wireless LAN, the peripheral device information includes information concerning the printer that among the plurality of printers is selected for routine use by the user.

The terminal 20 retains as utilization information profiles PF respective items of the utilization information acquired through connection to the respective wireless LANs. Therefore, when connecting again to a wireless LAN for which a connection log is retained in the terminal 20, the terminal 20 reads out the utilization information for the wireless LAN that is the connection target, from the corresponding utilization information profile PF. Then, the terminal 20 connects to the wireless LAN by using the connection information (SSID, encryption key, etc.) included in the utilization information, and can utilize a printer or peripheral device connected to the wireless LAN, by using the peripheral device information.

Meanwhile, the terminal 30 does not have a log of connection to any wireless LAN by the infrastructure mode and has not acquired any utilization information. In other words, the terminal 30 does not retain any utilization information profile Pf at all. Therefore, in order for the terminal 30 to connect a wireless LAN for which a connection log is retained in the terminal 20, the terminal 30 must acquire the utilization information for the wireless LAN that is the connection target. The data transfer system 10 is a system in order for the terminal 30 to acquire the utilization information profiles PF, which are retained in the terminal 20 and are the utilization information concerning the plurality of wireless LANs, from the terminal 20. The data transfer system 10 can be used, for example, for cases where the user who has utilized a wireless LAN through the terminal 20 utilizes the wireless LAN through the terminal 30, and for cases where the user utilizes a wireless LAN previously utilized through the terminal 20, through a new terminal 30 instead of the terminal 20 that has been used by the user thus far.

In the first embodiment, in the data transfer system 10, the terminal 20 and the terminal 30 are connected to each other by the ad hoc mode, and the terminal 20 transfers a utilization information profile PF directly to the terminal 30. Hereinafter, the configurations of the terminals 20 and 30 will be described.

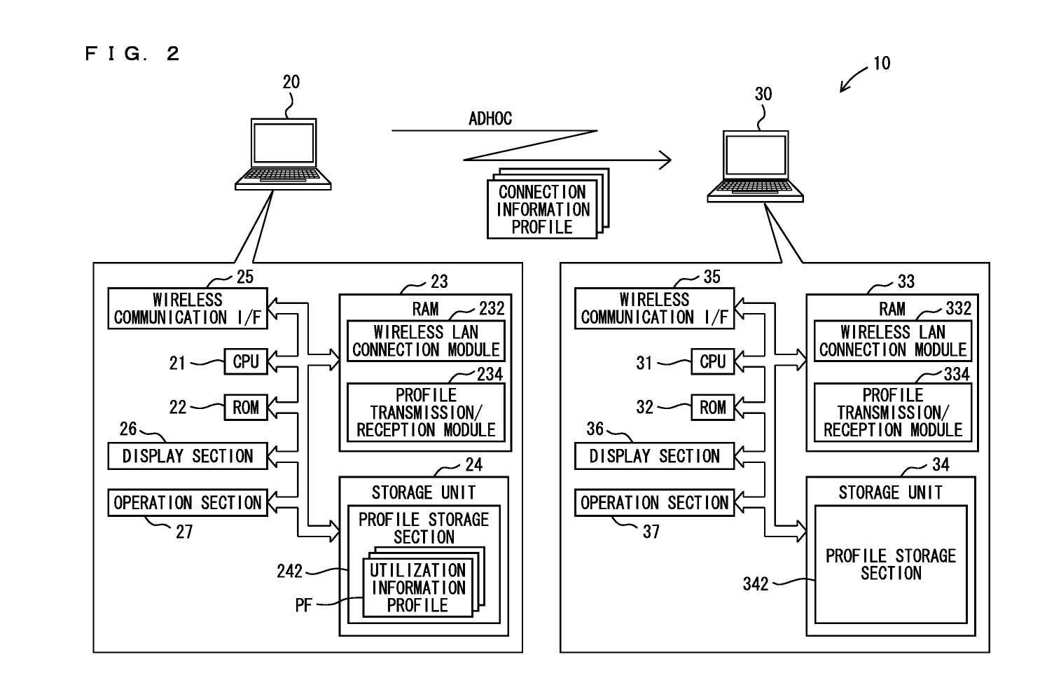

FIG. 2 is a diagram illustrating the configurations of the terminals 20 and 30 in the data transfer system 10. The terminals 20 and 30 have the same hardware configuration, and differ from each other only in that the terminal 20 previously retains the utilization information profiles PF in a storage unit 24. Thus, the configurations of the terminals 20 and 30 will be described by means of the terminal 20.

The terminal 20 includes a CPU (central processing unit) 21, a ROM (read only memory) 22, a RAM (random access memory) 23, the storage unit 24 composed of a storage section such as a hard disk or an SSD (solid state drive), a wireless communication interface (wireless communication I/F) 25, a display section 26, and an operation section 27. The CPU 21 controls the entire terminal 20. In addition, the CPU 21 reads a wireless LAN connection module 232 and a profile transmission/reception module 234 that are included in the RAM 23, and performs a process by each module, thereby implementing functions of an acquisition section and a transmission section.

The wireless LAN connection module 232 has a function for the terminal 20 to connect to a wireless LAN. When the terminal 20 starts connection to a wireless LAN, the wireless LAN connection module 232 receives radio waves (beacons) for wireless LANs through the wireless communication interface 25 to acquire the SSIDs of wireless LANs within the communication range of the terminal 20. Then, when the SSID of a wireless LAN that is a connection target is designated by the user, the wireless LAN connection module 232 acquires an encryption key for connecting to an access point of the wireless LAN that is the connection target, by a WPS (Wi-Fi protected setup). The WPS is a known technique, and thus the description thereof is omitted herein. It should be noted that the terminal 20 acquires the encryption key by the WPS in the present embodiment, but may acquire the encryption key through an input performed by the user with the operation section 27 such as a keyboard or a mouse.

The wireless LAN connection module 232 stores connection information including the acquired SSID and encryption key, as a utilization information profile PF in a profile storage section 242. When the connection to the wireless LAN is completed, the wireless LAN connection module 232 acquires peripheral device information (IP address, MAC address, etc.) that is information concerning a device that is designated and utilized by the user, among peripheral devices connected to the wireless LAN. The wireless LAN connection module 232 stores the acquired peripheral device information as a utilization information profile PF in the profile storage section 242.

When the terminal 20 connects again to a wireless LAN for which a connection log is retained in the terminal 20, the wireless LAN connection module 232 performs connection to the wireless LAN by using the connection information concerning the wireless LAN that is the connection target, which connection information is acquired from the corresponding utilization information profile PF in the profile storage section 242. By so doing, the operation by a user for connecting to the wireless LAN is facilitated. In addition, the wireless LAN connection module 232 displays information concerning peripheral device for which a log of use by a user is present in the terminal 20, on the display section 26 by using the peripheral device information, whereby use of the peripheral device by a user is facilitated.

Further, the wireless LAN connection module 232 has a function to perform direct communication with another wireless communication terminal within a predetermined communication range by using the wireless communication interface 25. The direct communication includes communications according to the ad hoc mode, Bluetooth communications, and infrared communications. In the following description, the wireless LAN connection module 232 of the present embodiment mainly performs, as direct communication, communication according to the ad hoc mode for wireless LAN. In the data transfer system 10, the terminals 20 and 30 are connected to each other by the ad hoc mode with the wireless LAN connection module 232 and the profile transmission/reception module 234 of the terminal 20 and a wireless LAN connection module 332 and a profile transmission/reception module 334 of the terminal 30, and the terminal 20 transfers a utilization information profile PF stored in the profile storage section 242 to the terminal 30.

Hereinafter, a data transfer process of transferring a utilization information profile PF from a first terminal (hereinafter, referred to as transfer source terminal) 20 to a second terminal (hereinafter, referred to as transfer destination terminal) 30 will be described.

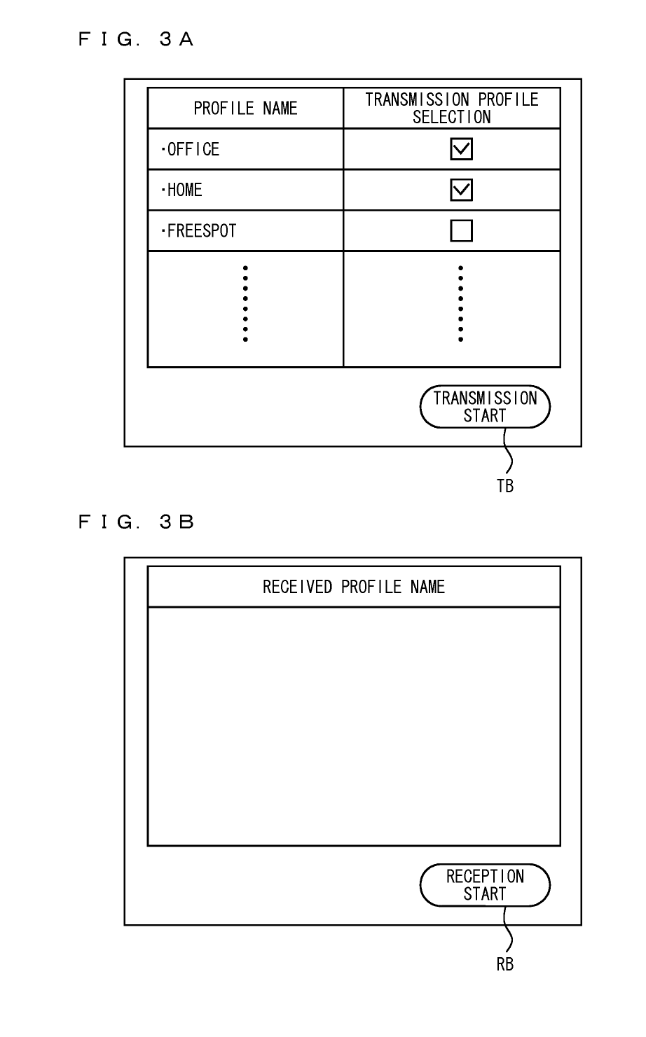

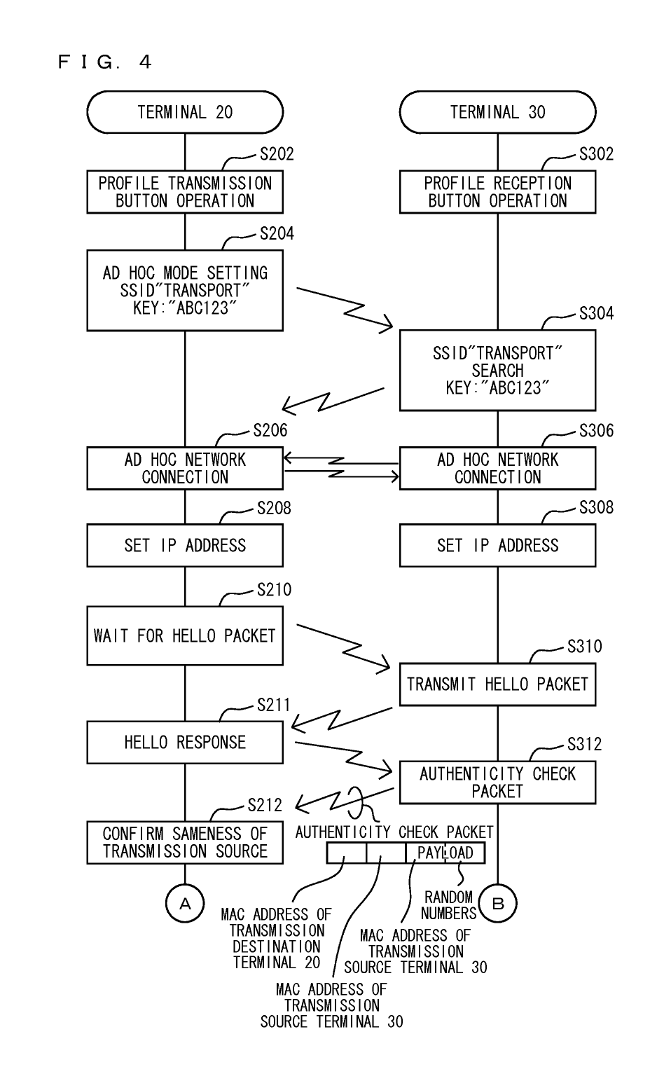

With reference to FIGS. 3A, 3B, 4, and 5, the data transfer process performed by the data transfer system 10 according to the first embodiment will be described. First, an example of a GUI (graphical user interface) that is shown to the user by the data transfer system 10 during the data transfer process will be described. The profile transmission/reception modules 234 and 334 of the transfer source terminal 20 and the transfer destination terminal 30 display operation screens for utilization information profile PF transfer, on the respective display sections 26 and 36, as shown in FIGS. 3A and 3B.

FIG. 3A is a diagram illustrating an example of a utilization information profile transmission screen that is displayed on the display section 26 of the transfer source terminal 20 that transmits a utilization information profile PF. The user selects a utilization information profile PF to be transferred to the transfer destination terminal 30, in the utilization information profile transmission screen by using the operation section 27 (e.g., a mouse), and operates a transmission start button TB, whereby a data transfer process by the transfer source terminal 20 is started.

FIG. 3B is a diagram illustrating an example of a utilization information profile reception screen that is displayed on the display section 36 of the transfer destination terminal 30 that receives a utilization information profile PF. In the utilization information profile reception screen, the user operates a reception start button RB by using an operation section 37 (e.g., a mouse), whereby a data transfer process by the transfer destination terminal 30 is started. When the transfer destination terminal 30 receives a utilization information profile PF through the data transfer process, the profile name of the received utilization information profile PF is displayed in a received profile field in FIG. 3B.

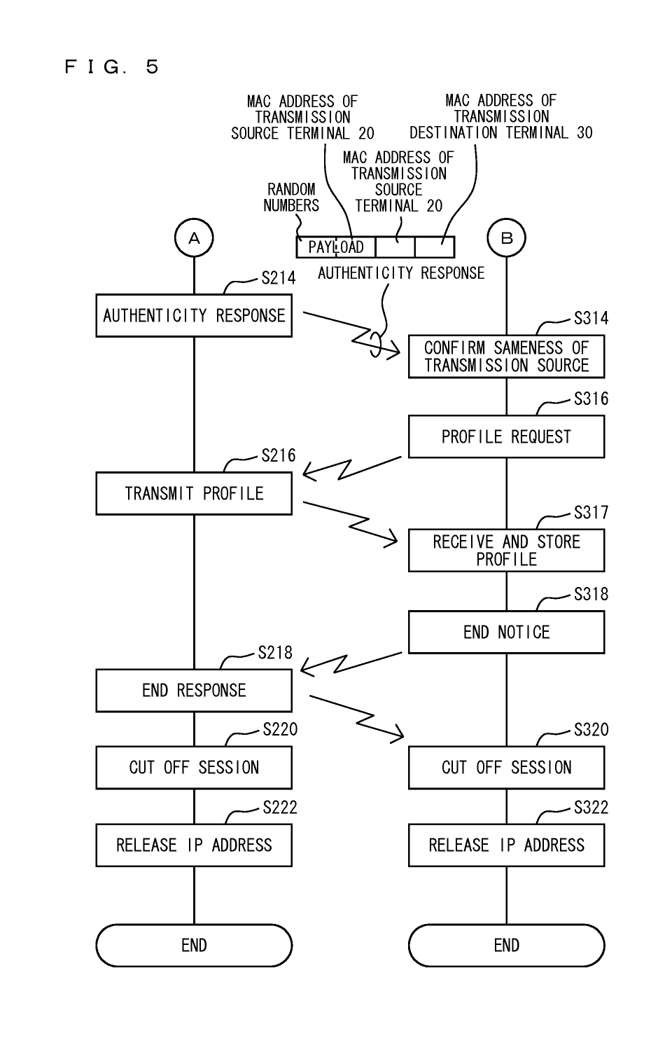

Next, a flow of the data transfer process performed by the data transfer system 10 according to the first embodiment will be described. FIGS. 4 and 5 are diagrams illustrating the flow of the data transfer process performed between the transfer source terminal 20 and the transfer destination terminal 30.

The data transfer process is started by the user operating at least one of either the transmission start button TB in the transfer source terminal 20 or the reception start button RB in the transfer destination terminal 30 (FIG. 4: step S202 and S302). The transfer source terminal 20 sets a communication mode of the wireless LAN connection module 232 for wireless LAN to the ad hoc mode, and transmits a beacon in which a prestored predetermined SSID (e.g., “TRANSPORT”) dedicated for the data transfer process is set, by using the profile transmission/reception module 234. This process corresponds to an operation in order for the transfer source terminal 20 to recognize the transfer destination terminal 30. In addition, the profile transmission/reception module 234 pre-sets an authentication key (e.g., “ABC123”) used for authentication of a communication partner, for the data transfer process (step S204).

Meanwhile, the transfer destination terminal 30 sets the communication mode of the wireless LAN connection module 332 for the wireless LAN to the ad hoc mode, sets an authentication key (“ABC123”) dedicated for the data transfer process, and searches for an SSID dedicated for the data transfer process (step S304). Then, upon reception of the beacon transmitted from the transfer source terminal 20, the transfer destination terminal 30 establishes an ad hoc connection to the transfer source terminal 20 by using the authentication key (steps S206 and S306). This process corresponds to an operation in order for the transfer destination terminal 30 to recognize the transfer source terminal 20. After the establishment of the ad hoc connection, the transfer source terminal 20 and the transfer destination terminal 30 respectively configure IP addresses (steps S208 and S308). At that time, if the network addresses in the IP addresses are different from each other, the transfer destination terminal 30 changes the own network address to the network address of the transfer source terminal 20.

Thereafter, the transfer source terminal 20 waits for reception of a HELLO packet for communication start confirmation that is transmitted from the communication partner that performs a data communication process (step S210). The transfer destination terminal 30 sets an address to a broadcast, and transmits a HELLO packet to the transfer source terminal 20 (step S310). The transfer source terminal 20 receives the HELLO packet transmitted by the transfer destination terminal 30, and transmits a HELLO response to the transfer destination terminal 30 for reception confirmation (step S211). If the transfer source terminal 20 does not receive the HELLO packet within a predetermined time after the establishment of the ad hoc connection, the transfer source terminal 20 cuts off the ad hoc connection for ensuring security.

Upon reception of the HELLO response, the transfer destination terminal 30 confirms authenticity of the communication partner prior to utilization information profile PF transfer. Specifically, as shown in FIG. 4, the transfer destination terminal 30 generates a packet including the MAC address of the transfer destination terminal 30 and random numbers in a payload, and transmits the packet to the transfer source terminal 20 as a check packet for confirming the authenticity of the communication partner (step S312). Upon reception of the authenticity check packet, the transfer source terminal 20 confirms whether the MAC address of the transfer destination terminal 30 included in the payload of the packet agrees with the MAC address of the transfer source of the previously received HELLO packet (step S212). Upon confirmation that the MAC address included in the payload of the authenticity check packet agrees with the MAC address in the HELLO packet, the transfer source terminal 20 newly generates an authenticity response packet from the authenticity check packet by rewriting the MAC address of the transfer destination terminal 30 included in the payload of the authenticity check packet with the MAC address of the transfer source terminal 20 and leaving the random number part as it is, as shown in FIG. 5. Then, the transfer source terminal 20 transmits the generated authenticity response packet as a response to the authenticity check packet, to the transfer destination terminal 30 (step S214).

The transfer destination terminal 30 confirms whether the MAC address of the transfer source terminal 20 included in the payload of the authenticity response packet agrees with the MAC address of the transfer source of the previously received HELLO response. At the same time, the transfer destination terminal 30 confirms whether the random numbers included in the authenticity response packet agree with the random numbers included in the authenticity check packet (step S314). Upon confirmation of the authenticity of the communication partner by the sameness of the MAC address and the sameness of the random numbers, the transfer destination terminal 30 requests a utilization information profile PF from the transfer source terminal 20 (step S316). Upon reception of the request for a utilization information profile PF from the transfer destination terminal 30, the transfer source terminal 20 (the CPU 21) reads, from the profile storage section 242, a utilization information profile PF selected and designated by the user, and transmits the utilization information profile PF to the transfer destination terminal 30 (step S216). Upon reception of the utilization information profile PF, the transfer destination terminal 30 (a CPU 31) stores the utilization information profile PF in a profile storage section 342 (step S317).

Thereafter, the transfer destination terminal 30 transmits a communication end packet to the transfer source terminal 20 (step S318), the transfer source terminal 20 transmits a response to the communication end packet, to the transfer destination terminal 30 (step S218), and then each of the transfer source terminal 20 and the transfer destination terminal 30 cuts off the session (steps S220 and S320). By so doing, each of the transfer source terminal 20 and the transfer destination terminal 30 releases the set IP address (steps S222 and S322) and ends the data transfer process.

It should be noted that in the data transfer process, the processes at steps S212 and S312 and the subsequent steps may be encrypted. As a method of the encryption, each of the transfer source terminal 20 and the transfer destination terminal 30 previously has a pre-shared key, an encryption mode that is a known encryption mode composed of RC4 encryption and a session key management method, and an encryption mode, such as AES (advanced encryption standard) or RSA, can be used by using the pre-shared key. Further, the process of confirming the authenticity of the communication partner can be omitted. In other words, steps S212 to S214 and steps S312 to S314 can be omitted.

As described above, in the data transfer system 10 according to the first embodiment of the present invention, the utilization information profile PF retained in the terminal 20 can be transferred to the terminal 30 via wireless means. In other words, the utilization information profile PF retained in the terminal 20 can easily be transferred to the terminal 30 via wireless means without using a storage medium (e.g., a USB memory) and without manually performing an input of the utilization information profile PF on the terminal 30. In addition, in the data transfer system 10 according to the first embodiment, the utilization information profile PF transfer is started by the user only selecting a utilization information profile PF to be transferred, in the terminal 20, and operating the transmission start button TB in the terminal 20 and the reception start button RB in the terminal 30, and the session is cut off after the end of the transfer. Thus, with security ensured, the utilization information profile PF transfer can be performed by an operation that is easy for the user.

### Second Embodiment

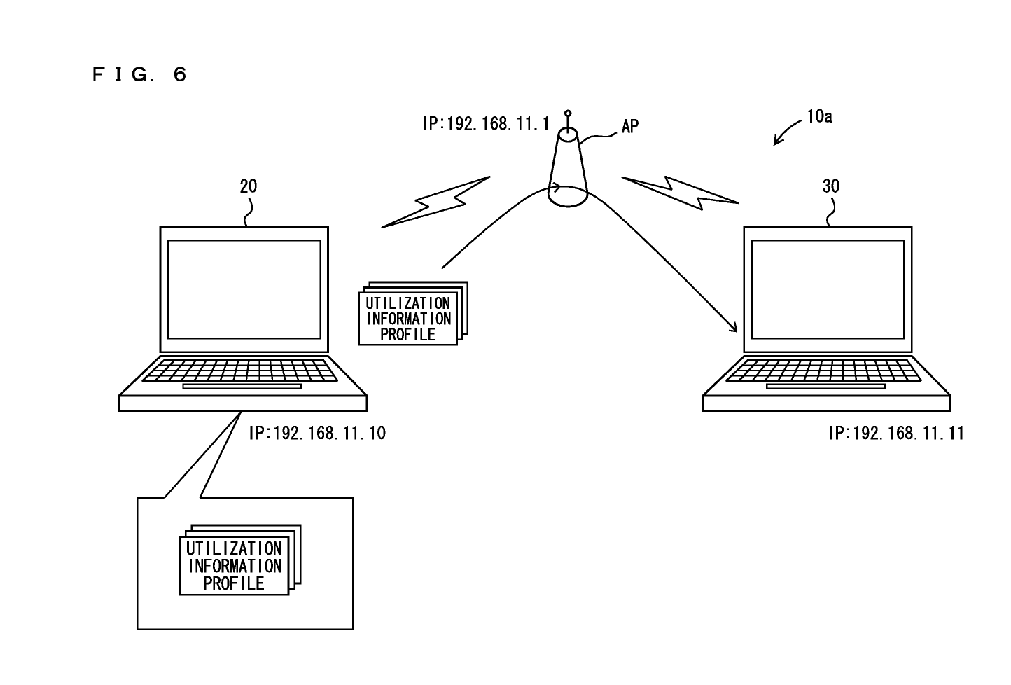

FIG. 6 is a diagram illustrating the configuration of a data transfer system 10a according to a second embodiment of the present invention. The second embodiment differs from the first embodiment in the communication mode for transferring a utilization information profile PF. In the first embodiment, the transfer source terminal 20 and the transfer destination terminal 30 are connected to each other by the ad hoc mode. However, in the second embodiment, as shown in FIG. 6, in the same wireless LAN, the transfer source terminal 20 and the transfer destination terminal 30 are connected to each other by the infrastructure mode through an access point AP, and utilization information profile PF transfer is performed. The internal configurations of the transfer source terminal 20 and the transfer destination terminal 30 are the same as those in the first embodiment, and thus the description thereof is omitted.

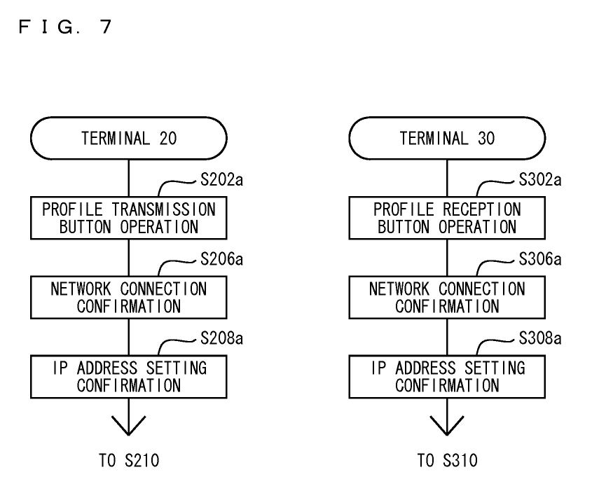

FIG. 7 is a diagram illustrating flow of a data transfer process performed by the data transfer system 10a according to the second embodiment. In the second embodiment, a description will be given on the assumption that the transfer source terminal 20 and the transfer destination terminal 30 are previously connected to an access point AP of the same wireless LAN.

Similarly to the first embodiment, the data transfer process performed by the data transfer system 10a according to the second embodiment is started by the user operating the transmission start button TB (see FIG. 3A) in the transfer source terminal 20 and the reception start button RB (see FIG. 3B) in the transfer destination terminal 30. When the transmission start button TB operates (step S202a), the transfer source terminal 20 confirms whether the communication mode of the profile transmission/reception module 234 is set to the infrastructure mode (step S206a). Similarly, when the reception start button RB operates (step S302a), the transfer destination terminal 30 confirms whether the communication mode of the profile transmission/reception module 334 is set to the infrastructure mode (step S306a). Here, when the both of the communication modes of the transfer source terminal 20 and the transfer destination terminal 30 are not set to the infrastructure mode and the both terminals are not connected to a wireless LAN, connection of the terminals to the wireless LAN is performed in front.

After confirming the connection to the wireless LAN, each of the transfer source terminal 20 and the transfer destination terminal 30 confirms whether an IP address is set (steps S208a and S308a). When an IP address is not set, the transfer source terminal 20 and the transfer destination terminal 30 set the IP addresses pre-stored by the profile transmission/reception modules 234 and 334. Subsequent processes are the same as the processes at steps S210 to S222 and S310 to S322 described with reference to FIGS. 4 and 5, and thus the description thereof is omitted.

As described above, in the data transfer system 10a according to the second embodiment of the present invention, the utilization information profile PF is transferred from the terminal 20 to the terminal 30 by the infrastructure mode through the access point. Therefore, even when the terminals 20 and 30 are distant from each other, if the terminals 20 and 30 are within the communication range of the same wireless LAN, the data transfer process can be performed. It should be noted that a method of transferring utilization information through an access point includes a method of transferring utilization information through the same access point, and a method of transferring utilization information through a plurality of access points (e.g., a WDS (wireless distribution system)).

(Modification 1)

In the embodiments described above, the user selects a utilization information profile PF to be transferred. However, a batch transmission button for transmitting the utilization information profiles PF retained in the transfer source terminal 20 in a batch may be provided in the utilization information profile transmission screen, and the data transfer process may be started by the user operating only the batch transmission button in the transfer source terminal 20 and the reception start button RB in the transfer destination terminal 30. By so doing, the operation performed by the user is further facilitated.

(Modification 2)

In the first embodiment described above, the transfer source terminal 20 and the transfer destination terminal 30 establish an ad hoc connection by the user operating the transmission start button TB and the reception start button RB. However, by operating the reception start button RB and the transmission start button TB, the profile transmission/reception modules 234 and 334 may generate PIN (personal identification number) codes, the user may input the PIN code generated by the terminal 20 to the terminal 30 by using the operation section 37 and input the PIN code generated by the terminal 30 to the terminal 20 by using the operation section 27, and the both terminals may transmit the inputted PIN codes to each other to confirm authenticity. Then, an ad hoc connection may be established. This process corresponds to an operation of inputting a PIN code for verifying the transfer source terminal 20, to the transfer destination terminal 30 from the outside, and an operation of inputting a PIN code for verifying the transfer destination terminal 30, to the transfer source terminal 20 from the outside. By so doing, with a higher level of security ensured, the data transfer process can be performed.

(Modification 3)

In the embodiments described above, after the data transfer process, both the transfer source terminal 20 and the transfer destination terminal 30 retain the utilization information profile PF. However, after the utilization information profile PF is transferred from the transfer source terminal 20 to the transfer destination terminal 30, the utilization information profile PF retained in the transfer source terminal 20 may be deleted. In other words, the utilization information profile PF is moved from the transfer source terminal 20 to the transfer destination terminal 30. This deletion process is effective when the user utilizes the wireless LAN with only the transfer destination terminal 30 after the data transfer process. Alternatively, two modes, a copy mode in which both the transfer source terminal 20 and the transfer destination terminal 30 retain the utilization information profile PF after the data transfer process, and a moving mode in which only the transfer destination terminal 30 retains the utilization information profile PF after the data transfer process as described above, may be provided.

(Modification 4)

In the embodiments described above, the data transfer process is performed between the two terminals. However, the utilization information profile PF may be transferred from one terminal that retains the utilization information profile PF to a plurality of terminals. Such data transfer can be implemented by the terminal that retains the utilization information profile PF, performing the data transfer process time-sequentially with the terminals that receive the utilization information profile PF. For example, in the data transfer process shown in FIGS. 4 and 5, ad hoc connections are established among a plurality of terminals at the substantially same time, and a terminal that transmits the utilization information profile PF sequentially receives HELLO packets transmitted from the other terminals and performs the processes at steps S210 and 310 and the subsequent steps time-sequentially with each terminal in order of the reception of the HELLO packets, whereby the data transfer can be implemented.

(Modification 5)

In the embodiments described above, the transfer source terminal 20 and the transfer destination terminal 30 that perform the data transfer process have the same internal configuration. However, the configurations of the both terminals may be different from each other, if the terminals have a function to perform the data transfer process. For example, the data transfer process may be performed between a mobile phone having a wireless LAN communication function and a computer (e.g., a notebook computer) having a wireless LAN communication function.

In the embodiments described above, the CPU implements each element of the terminal by executing firmware or a computer program stored in a memory. Each element of the present invention may be implemented by hardware or software as appropriate.

Further, when some or all of the functions of the present invention are implemented by software, the software (computer program) can be provided in the form of being stored in a computer-readable storage medium. In this invention, the “computer-readable storage medium” includes not only portable storage media such as flexible disks and CD-ROMs, but also various internal storage units in computers such as RAMs and ROMs, and external storage units fitted to computers such as hard disks.

While the invention has been described in detail, the foregoing description is in all aspects illustrative and not restrictive. For example, elements considered as being additional in light of the purport of the present invention may be omitted as necessary. Further, it will be understood that other than the modifications described above, various modifications and variations can be devised without departing from the scope of the invention.

What is claimed is:

1. A data-transfer method of carrying out data transfer between first and second terminals connectable to a wireless LAN, the first terminal pre-storing utilization information required in order for a terminal to utilize the wireless LAN, the data transfer method comprising:
a step of at least one of either the first terminal or the second terminal determining whether a predetermined operation requesting data transfer is present in said one terminal;
a step of the first terminal, on the basis of the predetermined operation, transferring the pre-stored utilization information via wireless means to the second terminal; and
a step of the second terminal storing the utilization information transferred from the first terminal.

2. The data transfer method according to claim 1, wherein in the transferring step, the first terminal transfers the utilization information directly to the second terminal.

3. The data transfer method according to claim 1, wherein in the transferring step, the first terminal transfers the utilization information to the second terminal through a relay device on the wireless LAN.

4. The data transfer method according to claim 1, wherein the utilization information is information in order for a terminal to connect to a relay device on the wireless LAN.

5. The data transfer method according to claim 1, wherein the utilization information is information on TCP/IP settings for a terminal.

6. The data transfer method according to claim 1, wherein the predetermined operation is at least one of either an operation in order for the first terminal to recognize the second terminal, or an operation in order for the second terminal to recognize the first terminal.

7. The data transfer method according to claim 1, wherein the predetermined operation is at least one of either an operation in order for the first terminal to recognize the second terminal, or an operation in order for the second terminal to recognize the first terminal, and in addition is at least one of either an operation of externally inputting, to the second terminal, a predetermined code for verifying the first terminal, or an operation of externally inputting, to the first terminal, a predetermined code for verifying the second terminal.

8. The data transfer method according to claim 1, wherein in the transferring step, the first terminal selects at least a portion of the pre-stored utilization information and transfers the portion to the second terminal.

9. A terminal connectable to a wireless LAN, the terminal comprising:
an acquisition section for acquiring via wireless means, from another terminal different from said terminal, utilization information required in order for a terminal to utilize the wireless LAN; and
a storage section for storing the utilization information acquired by the acquisition section.

10. A terminal connectable to a wireless LAN, the terminal comprising:
a storage section for storing utilization information required in order for a terminal to utilize the wireless LAN; and
a transmission section for transmitting via wireless means, to another terminal different from said terminal, the utilization information that the storage section stores.
